(19) United States
(12) Patent Application Publication
(10) Pub. No.: US 2009/0193211 A1
(43) Pub. Date: Jul. 30, 2009

(54) SOFTWARE AUTHENTICATION FOR COMPUTER SYSTEMS

(75) Inventors: Nanfang Hu, Palo Alto, CA (US); Xuezhang Dong, San Jose, CA (US)

Correspondence Address: FIALA & WEAVER, P.L.L.C.;C/O CPA GLOBAL, P.O. BOX 52050, MINNEAPOLIS, MN, 55402, US

(73) Assignee: BROADCOM CORPORATION, Irvine, CA (US)

(21) Appl. No.: 12/039,964

(22) Filed: Feb. 29, 2008

Related U.S. Application Data
(60) Provisional application No. 61/023,258, filed on Jan. 24, 2008.

(51) Int. Cl. G06F 12/00

(52) U.S. Cl. 711/163; 711/E12.001

(57) ABSTRACT

A technique for authenticating software in a computer system is provided that can be used to prevent unauthorized users from accessing or using certain features or resources of the computer system. In accordance with the technique, a relatively small hash table is authenticated at system boot up and then used during run-time to authenticate selected portions of a software image. The technique advantageously permits software to be authenticated in a manner that does not impose significant delays upon the boot-up time associated with the computer system. The technique is applicable to both general-purpose and special-purpose computer systems, including embedded systems.

### CROSS-REFERENCE TO RELATED APPLICATIONS

This application claims priority to Provisional U.S. Patent Application No. 61/023,258, entitled “Software Authentication in an Embedded System,” filed Jan. 24, 2008, the entirety of which is incorporated by reference herein.

### BACKGROUND OF THE INVENTION

1. Field of the Invention

The invention relates to techniques for authenticating software in a computer system.

2. Background

Many computer systems implement security features that are intended to prevent unauthorized users from accessing or using certain system features or resources. Such computer systems include both general-purpose computer systems as well as special-purpose computer systems. For example, certain embedded systems, such as those found in cellular telephones, implement security features to prevent malicious users (sometimes referred to as “hackers”) from tampering with the system to access or use system features and resources in an unauthorized manner. As will be readily understood by persons skilled in the relevant art(s), an embedded system is a type of special-purpose computer system that forms an integrated part of a device that also includes hardware and mechanical components.

One conventional method for attacking the security of an embedded system is to modify an existing software image used by the system to bypass any security checks normally performed by the system. The manner in which this type of attack is carried out is illustrated in FIGS. 1A and 1B. In particular, FIG. 1A shows a conventional embedded system 100 that includes a number of interconnected components including a processing unit 110, a random access memory (RAM) 120, and a flash memory 130. As shown in FIG. 1A, flash memory 130 stores a software image 140, which is an image of the operating system and application software used to run embedded system 100. During system boot-up, software image 140 is loaded to RAM 120 for execution by processing unit 110. For the purpose of this example, it is to be understood that the operating system and application software represented by software image 140 includes security features that are intended to prevent unauthorized access to or use of features and resources of embedded system 100.

FIG. 1B shows conventional embedded system 100 after it has been hacked by a malicious user. As shown in FIG. 1B, this hacking has resulted in the replacement of original software image 140 with a hacked software image 150. Hacked software image 150 comprises a modified version of original software image 140 in which the security features have been removed or otherwise bypassed. As a result, when embedded system 100 runs hacked software image 150, a user of embedded system 100 will be able to access and/or use features and resources of the system without having the proper authorization to do so.

In view of the foregoing, a technique is needed for authenticating software in an embedded system to prevent these types of attacks. The desired technique should be useful in preventing unauthorized users from accessing or using certain features or resources of the embedded system. Additionally, where the embedded system is a cellular telephone or other networked device, the desired technique should also help in preventing illegal uses and abuses of the network to which the embedded system is attached. Finally, the desired technique should be applicable to other types of special-purpose or general-purpose computer systems.

### BRIEF SUMMARY OF THE INVENTION

A technique for authenticating software in a computer system is described herein that may be used to prevent unauthorized users from accessing or using certain features or resources of the computer system. The technique advantageously permits software to be authenticated in a manner that does not impose significant delays upon the boot-up time associated with the computer system. The technique is applicable to both general-purpose and special-purpose computer systems, including embedded systems. When the technique is implemented in a cellular telephone or other networked device, it may be used to help in prevent illegal uses and abuses of the network to which the telephone or other networked device is attached.

In particular, a method is described herein for authenticating a software image configured for execution in a computer system. The computer system may be, for example, an embedded system. In accordance with the method, a hash table is authenticated during boot up of the computer system. The hash table includes a plurality of hash values each of which is uniquely associated with a different portion of the software image. Then, one of the portions of the software image is selected. A hash value is calculated for the selected portion. It is then determined whether the software image is authentic by comparing the hash value calculated for the selected portion to the hash value associated with the selected portion in the hash table.

In accordance with the foregoing method, the selecting, calculating and determining steps may be performed during execution of the software image by the computer system. For example, these steps may be performed on a periodic basis during execution of the software image by the computer system. Alternatively or additionally, the authenticating step may be performed during a first stage of the boot up of the computer system and the selecting, calculating and determining steps may be performed during a second stage of the boot up of the computer system.

In further accordance with the foregoing method, authenticating the hash table may include accessing a secure data block stored in a non-volatile memory of the computer system, wherein the secure data block includes the hash table. Additionally, selecting one of the portions of the software image may include randomly selecting one of the portions of the software image. The foregoing method may also include shutting down the computer system responsive to determining that the software image is not authentic.

A computer system is also described herein. The computer system includes a processing unit, a volatile memory communicatively connected to the processing unit, a first non-volatile memory communicatively connected to the volatile memory and the processing unit, and a second non-volatile memory communicatively connected to the volatile memory, the first non-volatile memory and the processing unit. The first non-volatile memory stores first stage boot loader logic while the second non-volatile memory stores second stage boot loader logic, a secure data block and a software image. The secure data block includes a hash table that includes a plurality of hash values each of which is uniquely associated with a different portion of the software image. In one embodiment, the volatile memory is a random access memory, the first non-volatile memory is a read only memory and the second non-volatile memory is a flash memory.

The processing unit of the foregoing computer system is configured to execute the first stage boot loader logic upon start up of the computer system, the first stage boot loader logic being configured to enable the processing unit to authenticate the secure data block and to load the second stage boot loader logic to the volatile memory. The processing unit is further configured to execute the second stage boot loader logic responsive to the loading of the second stage boot loader logic to the volatile memory, the second stage boot loader logic being configured to enable the processing unit to load the software image to the volatile memory. The processing unit is still further configured to execute logic within the software image responsive to the loading of the software image to the volatile memory, wherein the logic within the software image includes logic configured to enable the processing unit to select one of the portions of the software image, to calculate a hash value for the selected portion, and to determine if the software image is authentic by comparing the hash value calculated for the selected portion to the hash value associated with the selected portion in the hash table.

In one embodiment of the foregoing system, the logic within the software image includes logic configured to enable the processing unit to periodically perform the functions of selecting one of the portions of the software image, calculating a hash value for the selected portion, and determining if the software image is authentic by comparing the hash value calculated for the selected portion to the hash value associated with the selected portion in the hash table.

In a further embodiment of the foregoing system, the second stage boot loader is further configured to enable the processing unit to select one of the portions of the software image, to calculate a hash value for the selected portion, and to determine if the software image is authentic by comparing the hash value calculated for the selected portion to the hash value associated with the selected portion in the hash table.

In accordance with the foregoing system, the logic configured to enable the processing unit to select one of the portions of the software image may include logic configured to enable the processing unit to randomly select one of the portions of the software image. Additionally, the logic within the software image may include logic configured to enable the processing unit to shut down the computer system responsive to a determination that the software image is not authentic.

A computer program product is also described herein. The computer program product includes a computer-readable medium having computer program logic recorded thereon for enabling a processing unit in a computer system to authenticate a software image. The computer system may be, for example, an embedded system. The computer program logic includes first means, second means and third means. The first means are for enabling the processing unit to select a portion of the software image, the software image being divided into a plurality of different portions. The second means are for enabling the processing unit to calculate a hash value for the selected portion. The third means are for enabling the processing unit to determine if the software image is authentic by comparing the hash value calculated for the selected portion to a hash value associated with the selected portion in a hash table that was authenticated during boot up of the computer system. The hash table may comprise part of a secure data block that is stored in a non-volatile memory of the computer system.

The foregoing computer program product may further include additional means for enabling the processing unit to execute the first means, the second means and the third means during execution of the software image. The first means, the second means and the third means may be executed on a periodic basis during execution of the software image. The foregoing computer program product may also comprising additional means for enabling the processing unit to execute the first means, the second means and the third means during boot up of the computer system.

In accordance with the foregoing computer program product, the first means may include means for enabling the processing unit to randomly select one of the portions of the software image. The foregoing computer program product may also include additional means for enabling the processing unit to shut down the computer system responsive to a determination that the software image is not authentic.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1A is a block diagram of a conventional embedded system in which a software image of operating system and application programs is stored in a flash memory.

FIG. 1B is a block diagram of a conventional embedded system in which an original software image stored in a flash memory has been replaced with a hacked software image.

FIG. 2 is a block diagram of an embedded system that performs software authentication in accordance with an embodiment of the present invention.

FIG. 3 depicts a flowchart of a boot up sequence used by an embedded system in accordance with an embodiment of the present invention.

FIG. 4 is a conceptual illustration of the generation of hash values for discrete portions of a software image and the authentication of those portions at run-time in accordance with an embodiment of the present invention.

FIG. 5 depicts a flowchart of a first stage boot loading process that authenticates a hash table in accordance with an embodiment of the present invention.

FIG. 6 depicts a flowchart of a run-time process that authenticates selected blocks of a software image in accordance with an embodiment of the present invention.

FIG. 7 depicts a flowchart of a second stage boot loading process that authenticates selected blocks of a software image in accordance with an embodiment of the present invention.

FIG. 8 is a block diagram of a general-purpose computer system in which an embodiment of the present invention may be implemented.

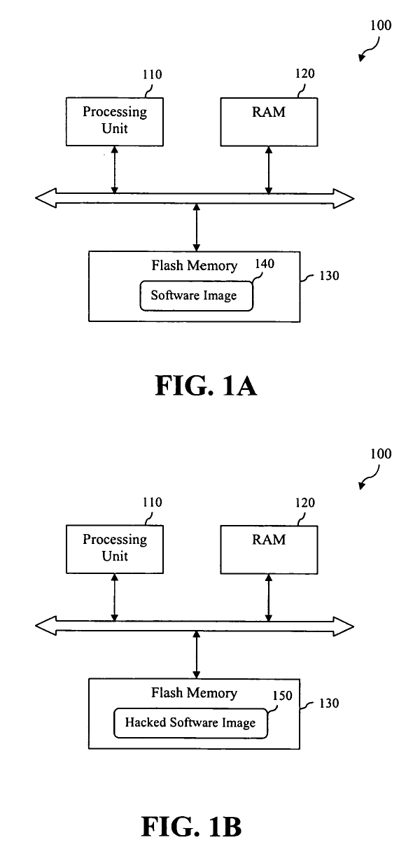

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### Introduction

A technique for authenticating software in a computer system in accordance with an embodiment of the present invention will now be described. The technique advantageously permits software to be authenticated in a manner that does not impose significant delays upon the boot-up time associated with the computer system. The technique may be implemented both in general-purpose and special-purpose computer systems, including embedded systems.

### B. Embedded System Implementation

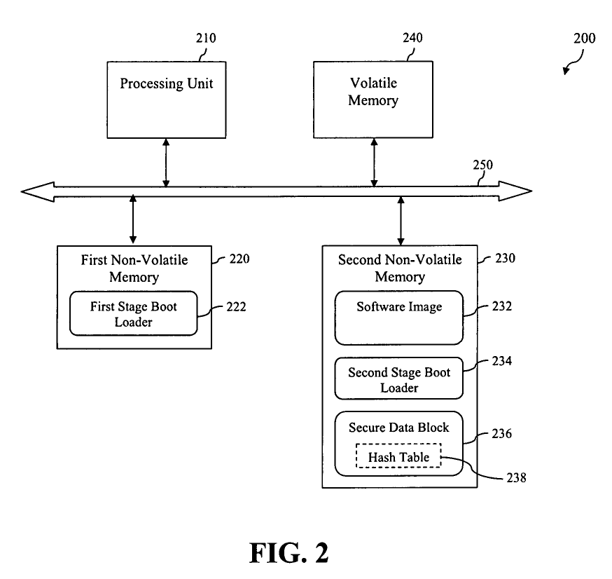

FIG. 2 is a block diagram of an embedded system 200 that performs software authentication in accordance with an embodiment of the present invention. In one embodiment, embedded system 200 is an integrated part of a General Packet Radio Services (GPRS)/Global System for Mobile (GSM) baseband processor chip used in a cellular telephone. However, the invention is not so limited and persons skilled in the relevant art(s) will readily appreciate that embedded system 200 may comprise an integrated part of any number of devices or systems, including but not limited to consumer electronics devices, household appliances, office equipment, banking machines, telecommunication and networking devices, transportation systems, medical equipment, and industrial control systems, to name only a few.

As shown in FIG. 2, embedded system 200 includes a number of hardware components including a processing unit 210, a first non-volatile memory 220, a second non-volatile memory 230 and a volatile memory 240. Each of these components is communicatively connected to the other via a communication infrastructure 250, which may comprise a bus or a number of interconnected busses depending upon the implementation.

Processing unit 210 is a component that is configured to execute software instructions, also referred to herein as computer program instructions or computer program logic. In particular, processing unit 210 is configured to execute software instructions that are stored in either first non-volatile memory 220 or volatile memory 240 dependent upon a mode of operation. Processing unit 210 may comprise one or more general-purpose or special-purpose processors. A processor within processing unit 210 may also include multiple processing cores.

First non-volatile memory 220 and second non-volatile memory 230 are memories that are used to persistently store information within embedded system 200 even when embedded system 200 is not powered. In one embodiment, first non-volatile memory 220 comprises a read only memory (ROM) while second non-volatile memory 220 comprises a flash memory, although the invention is not so limited. Persons skilled in the relevant art(s) will readily appreciate that other non-volatile memory types may be used to implement these components.

As shown in FIG. 2, first non-volatile memory 220 stores a first stage boot loader 222. First stage boot loader 222 is a computer program that is automatically executed by processing unit 210 when embedded system 200 is powered on or reset by a user. The functions of first stage boot loader 222 include authenticating a second stage boot loader 234 and a secure data block 236 stored in second non-volatile memory 230 and loading the second stage boot loader 234 to volatile memory 240 for subsequent execution by processing unit 210.

Second non-volatile memory 230 stores a software image 232, a second stage boot loader 234 and a secure data block 236. Software image 232 comprises an image of operating system and application software used to run embedded system 200. Second stage boot loader 232 is a computer program that is executed by processing unit 210 responsive to being loaded into volatile memory 240 by first stage boot loader 222. The functions of second stage boot loader 232 include loading software image 232 to volatile memory 240 for subsequent execution by processing unit 210. Secure data block 236 is a collection of data used by the operating system and application software of embedded system 200 to perform security functions, some of which will be described in more detail herein. As shown in FIG. 2, secure data block 236 includes a hash table 238.

Volatile memory 240 is a memory that is used to store software instructions to be executed by processing unit 210 as well as certain data used or generated by volatile memory 240 during execution of those software instructions. In one embodiment, volatile memory 240 comprises a random access memory (RAM) although the invention is not so limited. Persons skilled in the relevant art(s) will readily appreciate that other volatile memory types may be used to implement this component.

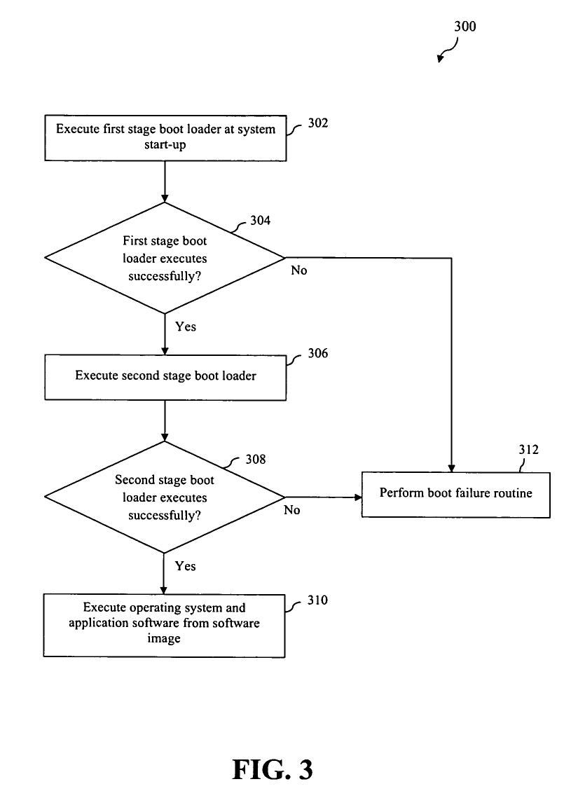

FIG. 3 depicts a flowchart of a boot up sequence used by embedded system 200 in accordance with an embodiment of the present invention. As shown in FIG. 3, the boot up sequence begins at step 302, in which processing unit 210 executes first stage boot loader 222 from first non-volatile memory 220. This step occurs whenever system 200 is powered on or reset by a user. As shown at decision step 304, if first stage boot loader 222 does not execute successfully, then processing unit 210 performs a boot failure routine as shown at step 312. Depending upon the implementation, the performance of the boot failure routine may include sending an error message to a user interface of embedded system 200 (not shown in FIG. 2) and/or shutting down embedded system 200.

If first stage boot loader 222 does execute successfully, then at step 306 processing unit 210 executes second stage boot loader 234, which has been loaded from second non-volatile memory 230 to volatile memory 240 by first stage boot loader 222. As shown at decision step 308, if second stage boot loader 234 does not execute successfully, then processing unit 210 performs a boot failure routine as shown at step 312. As noted above, the performance of the boot failure routine may include sending an error message to a user interface of embedded system 200 and/or shutting down embedded system 200.

If second stage boot loader 234 does execute successfully, then at step 310 processing unit 210 executes operating system and application software embodied in software image 232, which has been loaded from second non-volatile memory 230 to volatile memory 240 by second stage boot loader 234. The execution of the operating system and application software by processing unit 210 enables embedded system 200 to perform its intended run-time functions.

However, it is possible that logic within software image 232 has been modified by a malicious user to change the behavior of that logic. For example, logic within software image 232 may have been modified by a malicious user to disable or bypass certain security features implemented by that logic. To address this issue, embedded system 200 advantageously authenticates software image 232 to determine whether the image is valid (i.e., whether it matches an authorized or original version of the image) or whether it has been modified by a malicious user.

One approach to authenticating software image 232 would be to authenticate the entire image during the boot up sequence. However, such an approach can introduce significant delay into the boot up sequence, particularly where the image is large. If the boot up sequence it too time consuming, then this will negatively impact a user of a device or system that includes embedded system 200.

To avoid this problem, an embodiment of the present invention authenticates discrete portions of software image 232 during run-time. To achieve this, software image 232 is divided into a plurality of blocks, wherein each block represents a different portion of software image 232. A hash function is then applied to each block to generate a unique hash value, or signature, for each block. The hash values are organized in a hash table 238, which is stored in secure data block 236 within second non-volatile memory 230 and authenticated during boot-up.

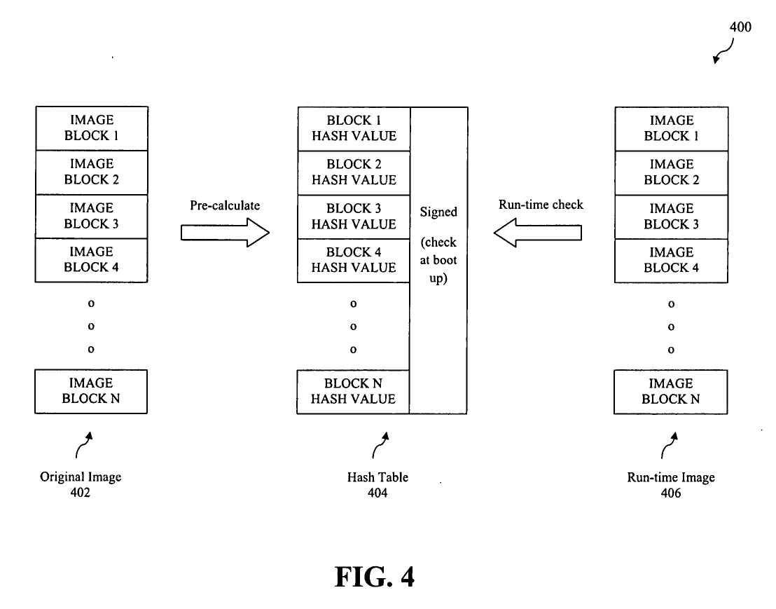

FIG. 4 is a conceptual illustration 400 of this approach. As shown in FIG. 4, an original software image 402 is divided into a plurality of blocks, denoted image blocks 1 through N. A hash function is then applied to each of these blocks to generate a corresponding hash value which is stored in a hash table 404. An encryption function is used to generate a unique signature for hash table 404. This unique signature is stored along with hash table 404 in non-volatile memory and is used to authenticate hash table 404 during boot up. Since hash table 404 is relatively small, the authentication of hash table 404 does not introduce much delay to the boot up sequence. For example, in one embodiment, hash table 404 is approximately 64 kilobytes (K) to 256 K in size.

The generation of hash table 404 from original image 402 is preferably a process that occurs prior to distribution of the embedded system to a user. However, if original software image 402 is changed for a legitimate reason after distribution to the user (e.g., the operating system or application software of the embedded system is upgraded), then hash table 404 may be replaced with a new hash table by overwriting the non-volatile memory in which hash table 404 is stored.

After boot up, the processing unit periodically checks a run-time image 406 of the operating system and application software. The processing unit may execute the run-time checking as a background thread. To perform this periodic checking, run-time image 406 is partitioned into N blocks in the same manner as original image 402. Then, on a periodic basis, one of the N blocks of run-time image 406 is selected and the same hash function that was used to generate the hash values in hash table 404 is applied to the selected block to calculate a hash value. The hash value calculated for the selected block is then compared to the hash value stored for the selected block in hash table 404. If the hash values match, then the block is deemed valid. If the hash values do not match then the block has failed authentication and the entire software image may be deemed corrupt. Appropriate steps may then be taken responsive to the detection of a corrupt software image. Depending upon the implementation, such steps may include shutting down the embedded system, terminating certain functionality of the embedded system, or restricting access to certain resources of the embedded system.

To ensure integrity of the entire run-time image 406, the run-time checking may be configured to randomly check different blocks of the image, or check different blocks in a predefined sequence. Where certain blocks are deemed more significant than others from a functionality standpoint and/or security standpoint, the run-time checking can be configured to check those blocks exclusively or more frequently than other blocks.

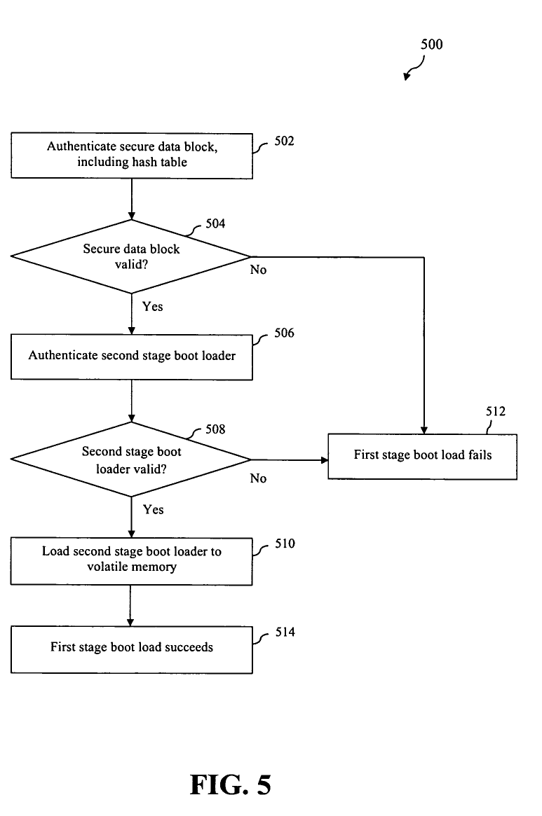

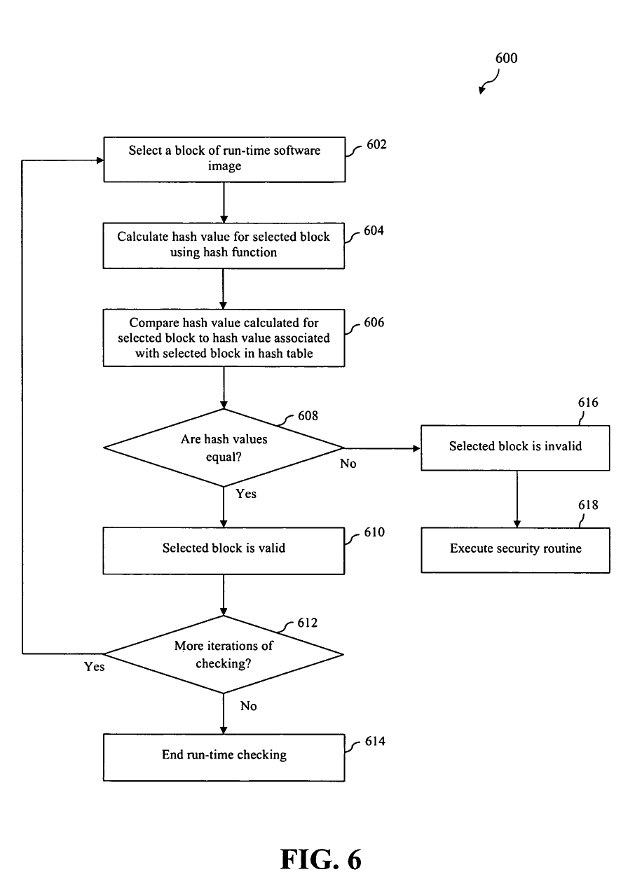

The manner in which the components of embedded system 200 operate to implement the foregoing approach to software authentication will now be described in reference to FIGS. 5 and 6.

In particular, FIG. 5 depicts a flowchart 500 of certain operations performed responsive to execution of first stage boot loader 222 by processing unit 210. As shown in FIG. 5, the method of flowchart 500 begins at step 502, in which first stage boot loader 222 authenticates secure data block 236, which includes hash table 238. To authenticate hash table 238, first stage boot loader 222 may calculated a signature value based on the contents of hash table 238 and then compare the calculated signature value to a stored signature value associated with hash table 238. Where embedded system 200 is part of a cellular telephone, other data that may be stored in secure data block 236 may include an International Mobile Equipment Identity (IMEI) number, digital rights management (DRM) keys, and so on. This information is also authenticated during step 502.

As shown at decision step 504, if first stage boot loader 222 determines that any of the data in the secure data block is not valid, then the first stage boot fails as shown at step 512. However, if first stage boot loader 222 determines that the data in secure data block is valid, then processing proceeds to step 506, in which second stage boot loader 222 authenticates second stage boot loader 234.

As shown at decision step 508, if first stage boot loader 222 determines that second stage boot loader 234 is not valid, then the first stage boot fails as shown at step 512. However, if first stage boot loader 222 determines that second stage boot loader 234 is valid, then processing proceeds to step 510, in which first stage boot loader 222 loads second stage boot loader 234 to volatile memory 240 for subsequent processing by processing unit 210. The first stage boot load then ends successfully as shown at step 514.

FIG. 6 depicts a flowchart 600 of certain operations performed responsive to the execution of a run-time checking process by processing unit 210. In an embodiment, the run-time checking process is part of the operating system software embodied in software image 232.

As shown in FIG. 6, the method of flowchart begins at step 602, in which the run-time checking process selects a block of the run-time software image. Depending upon the implementation, the block may be selected at random, in accordance with a predefined block sequence, or based on some other selection algorithm. At step 604, the run-time checking process calculates a hash value for the selected block using the same hash function that was used to generate the hash values in hash table 238.

At step 606, the run-time checking process compares the hash value calculated for the selected block in step 604 to the hash value associated with the selected block stored in hash table 238. As shown at decision step 608, if the hash values are not equal, then the selected block is deemed invalid as shown at step 616, and a security routine is executed as shown at step 616. The execution of the security routine is premised on the assumption that the run-time software image is corrupt and may include performing certain actions such as shutting down the embedded system, terminating certain functionality of the embedded system, or restricting access to certain resources of the embedded system.

However, if it is determined at decision step 608 that the hash values are equal, then the selected block is deemed valid as shown at step 610. Control then flows to decision step 612, in which the run-time checking process determines if more iterations of checking are necessary. The number of iterations used by the run-time checking process may vary depending upon the implementation and may comprise one iteration, a number of iterations equal to the number of blocks in the run-time software image, or some other number of iterations. The frequency at which such iterations are performed may also vary depending upon the implementation.

If more iterations of checking are required, then control returns to step 602. If no more iterations of checking are required, then the run-time checking process ends as shown at step 614.

In accordance with the foregoing methods, the relatively small hash table 238 is authenticated during the boot-up sequence of embedded system 200, while blocks of the software image are checked at run-time. This allows software authentication to be performed in a manner that does not impose great delays upon the boot-up sequence. Such an approach is particularly valuable where the software image is large.

In accordance with an alternative embodiment of the present invention, checking of the blocks of the software image may also optionally be implemented during the boot-up sequence. In particular, second stage boot loader 234 may be configured to check a small subset of the blocks of the software image. While this does add delay to the boot-up sequence, the delay is less than if the whole image was checked and does provide a way for potentially aborting operation prior to run-time.

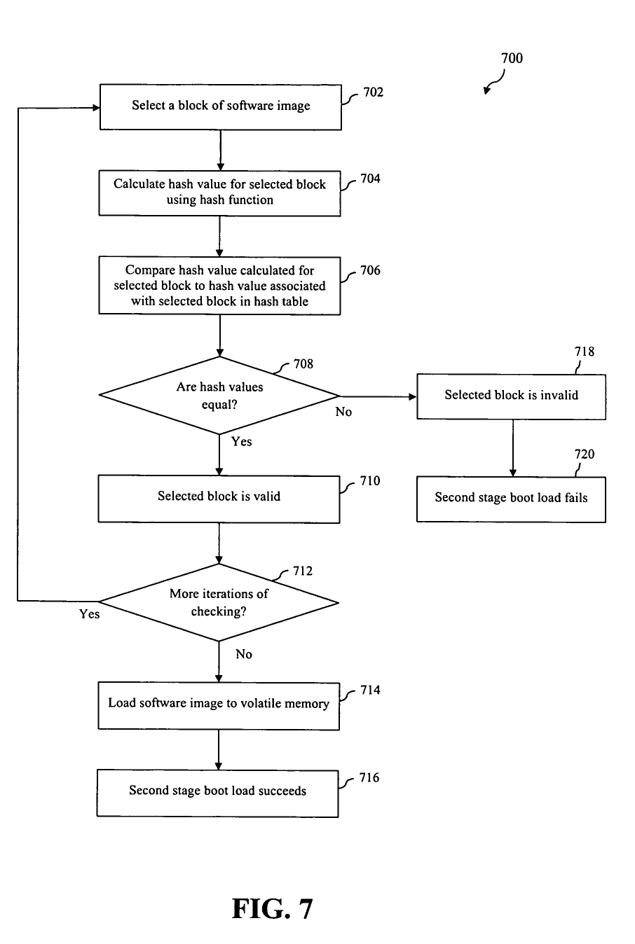

FIG. 7 depicts a flowchart 700 of steps performed by second stage boot loader 234 in accordance with such an embodiment. As shown in FIG. 7, the method of flowchart 700 begins at step 702, in which second stage boot loader 234 selects a block of software image 232. At step 704, second stage boot loader 234 calculates a hash value for the selected block using the same hash function that was used to generate the hash values in hash table 238.

At step 706, second stage boot loader 234 compares the hash value calculated for the selected block in step 704 to the hash value associated with the selected block stored in hash table 238. As shown at decision step 708, if the hash values are not equal, then the selected block is deemed invalid as shown at step 718, and the second stage boot load fails as shown at step 720.

However, if it is determined at decision step 708 that the hash values are equal, then the selected block is deemed valid as shown at step 710. Control then flows to decision step 712, in which second stage boot loader 234 determines if more iterations of checking are necessary. If more iterations of checking are required, then control returns to step 702. If no more iterations of checking are required, then processing proceeds to step 714, in which second stage boot loader 234 loads software image 232 to volatile memory 240 for subsequent processing by processing unit 210. The second stage boot load then ends successfully as shown at step 716.

### C. General-Purpose Computer System Implementation

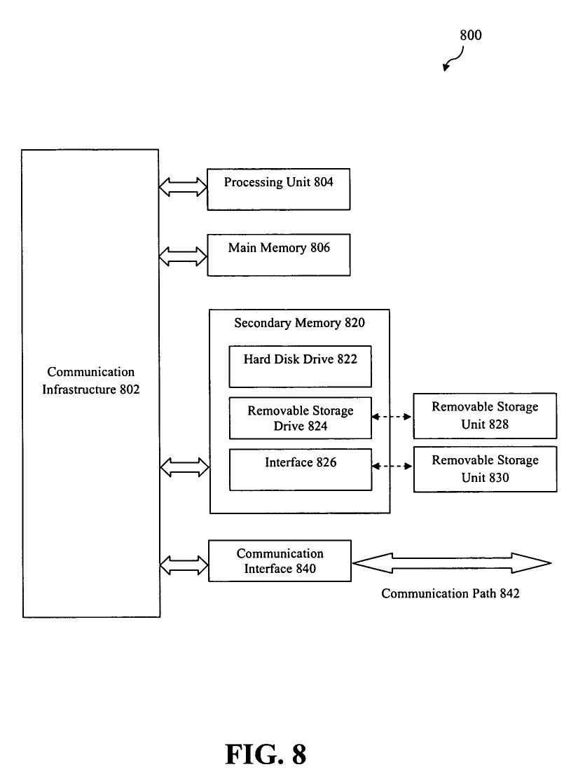

The present invention is not limited to embedded systems, but may also be implemented in other computer systems, such as other types of special-purpose or general-purpose computer systems. An example of a general-purpose computer system 800 that may implement the present invention is depicted in FIG. 8.

As shown in FIG. 8, computer system 800 includes a processing unit 804 that includes one or more processors. Processor unit 804 is connected to a communication infrastructure 802, which may comprise, for example, a bus or a network.

Computer system 800 also includes a main memory 806, preferably random access memory (RAM), and may also include a secondary memory 820. Secondary memory 820 may include, for example, a hard disk drive 822, and/or a removable storage drive 824. Removable storage drive 824 may comprise a floppy disk drive, a magnetic tape drive, an optical disk drive, a flash memory, or the like. Removable storage drive 824 reads from and/or writes to a removable storage unit 828 in a well-known manner. Removable storage unit 828 may comprise a floppy disk, memory stick, magnetic tape, optical disk, or the like, which is read by and written to by removable storage drive 824. As will be appreciated by persons skilled in the relevant art(s), removable storage unit 828 includes a computer usable storage medium having stored therein computer software and/or data.

In alternative implementations, secondary memory 820 may include other similar means for allowing computer programs or other instructions to be loaded into computer system 800. Such means may include, for example, a removable storage unit 830 and an interface 826. Examples of such means may include a program cartridge and cartridge interface (such as that found in video game devices), a removable memory chip (such as an EPROM, or PROM) and associated socket, and other removable storage units 830 and interfaces 826 which allow software and data to be transferred from the removable storage unit 830 to computer system 800.

Computer system 800 may also include a communications interface 840. Communications interface 840 allows software and data to be transferred between computer system 800 and external devices. Examples of communications interface 840 may include a modem, a network interface (such as an Ethernet card), a communications port, a PCMCIA slot and card, or the like. Software and data transferred via communications interface 840 are in the form of signals which may be electronic, electromagnetic, optical, or other signals capable of being received by communications interface 840. These signals are provided to communications interface 840 via a communications path 842. Communications path 842 carries signals and may be implemented using wire or cable, fiber optics, a phone line, a cellular phone link, an RF link and other communications channels.

As used herein, the terms “computer program medium” and “computer usable medium” are used to generally refer to media such as removable storage unit 828, removable storage unit 830 or a hard disk installed in hard disk drive 822. Computer program medium and computer useable medium can also refer to memories, such as main memory 806 and secondary memory 820, which can be semiconductor devices (e.g., DRAMs, etc.). These computer program products are means for providing software to computer system 800.

Computer programs (also called computer control logic, programming logic, or logic) are stored in main memory 806 and/or secondary memory 820. Computer programs may also be received via communications interface 840. Such computer programs, when executed, enable the computer system 800 to authenticate software in a manner previously described herein. For example, a computer program executed by processing unit 804 may operate to authenticate blocks of a software image or program stored in main memory 806 or secondary memory 820 using a hash table that was authenticated during boot up of computer system 800. Accordingly, such computer programs represent controllers of the computer system 800. Where the invention is implemented using software, the software may be stored in a computer program product and loaded into computer system 800 using removable storage drive 824, interface 826, or communications interface 840.

The invention is also directed to computer program products comprising software stored on any computer useable medium. Such software, when executed in one or more data processing devices, causes a data processing device(s) to operate as described herein. Embodiments of the present invention employ any computer useable or readable medium, known now or in the future. Examples of computer useable mediums include, but are not limited to, primary storage devices (e.g., any type of random access memory) and secondary storage devices (e.g., hard drives, floppy disks, CD ROMS, zip disks, tapes, magnetic storage devices, optical storage devices, MEMs, nanotechnology-based storage device, etc.).

### D. Conclusion

While various embodiments of the present invention have been described above, it should be understood that they have been presented by way of example only, and not limitation. It will be understood by those skilled in the relevant art(s) that various changes in form and details may be made to the embodiments of the present invention described herein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for authenticating a software image configured for execution in a computer system, the method comprising:
authenticating a hash table during boot up of the computer system, wherein the hash table includes a plurality of hash values each of which is uniquely associated with a different portion of the software image;
selecting one of the portions of the software image;
calculating a hash value for the selected portion; and
determining if the software image is authentic by comparing the hash value calculated for the selected portion to the hash value associated with the selected portion in the hash table.

2. The method of claim 1, wherein the computer system is an embedded system.

3. The method of claim 1, wherein authenticating the hash table comprises accessing a secure data block stored in a non-volatile memory of the computer system, wherein the secure data block includes the hash table.

4. The method of claim 1, wherein selecting one of the portions of the software image comprises randomly selecting one of the portions of the software image.

5. The method of claim 1, wherein the selecting, calculating and determining steps are performed during execution of the software image by the computer system.

6. The method of claim 5, wherein the selecting, calculating and determining steps are performed on a periodic basis during execution of the software image by the computer system.

7. The method of claim 1, wherein the authenticating step is performed during a first stage of the boot up of the computer system and wherein the selecting, calculating and determining steps are performed during a second stage of the boot up of the computer system.

8. The method of claim 1, further comprising:
shutting down the computer system responsive to determining that the software image is not authentic.

9. A computer system, comprising:
a processing unit;
a volatile memory communicatively connected to the processing unit;
a first non-volatile memory communicatively connected to the volatile memory and the processing unit, the first non-volatile memory storing first stage boot loader logic; and
a second non-volatile memory communicatively connected to the volatile memory, the first non-volatile memory and the processing unit, the second non-volatile memory storing second stage boot loader logic, a secure data block and a software image, wherein the secure data block includes a hash table that includes a plurality of hash values each of which is uniquely associated with a different portion of the software image;
wherein the processing unit is configured to execute the first stage boot loader logic upon start up of the computer system, the first stage boot loader logic being configured to enable the processing unit to authenticate the secure data block and to load the second stage boot loader logic to the volatile memory,
wherein the processing unit is further configured to execute the second stage boot loader logic responsive to the loading of the second stage boot loader logic to the volatile memory, the second stage boot loader logic being configured to enable the processing unit to load the software image to the volatile memory, and
wherein the processing unit is further configured to execute logic within the software image responsive to the loading of the software image to the volatile memory, wherein the logic within the software image includes logic configured to enable the processing unit to select one of the portions of the software image, to calculate a hash value for the selected portion, and to determine if the software image is authentic by comparing the hash value calculated for the selected portion to the hash value associated with the selected portion in the hash table.

10. The system of claim 9, wherein the volatile memory is a random access memory, the first non-volatile memory is a read only memory and the second non-volatile memory is a flash memory.

11. The system of claim 9, wherein the logic configured to enable the processing unit to select one of the portions of the software image comprises logic configured to enable the processing unit to randomly select one of the portions of the software image.

12. The system of claim 9, wherein the logic within the software image includes logic configured to enable the processing unit to periodically perform the functions of selecting one of the portions of the software image, calculating a hash value for the selected portion, and determining if the software image is authentic by comparing the hash value calculated for the selected portion to the hash value associated with the selected portion in the hash table.

13. The system of claim 9, wherein the second stage boot loader is further configured to enable the processing unit to select one of the portions of the software image, to calculate a hash value for the selected portion, and to determine if the software image is authentic by comparing the hash value calculated for the selected portion to the hash value associated with the selected portion in the hash table.

14. The system of claim 9, wherein the logic within the software image includes logic configured to enable the processing unit to shut down the computer system responsive to a determination that the software image is not authentic.

15. A computer program product comprising a computer-readable medium having computer program logic recorded thereon for enabling a processing unit in a computer system to authenticate a software image, the computer program logic comprising:
first means for enabling the processing unit to select a portion of the software image, the software image being divided into a plurality of different portions;
second means for enabling the processing unit to calculate a hash value for the selected portion; and
third means for enabling the processing unit to determine if the software image is authentic by comparing the hash value calculated for the selected portion to a hash value associated with the selected portion in a hash table that was authenticated during boot up of the computer system.

16. The computer program product of claim 15, wherein the computer system is an embedded system.

17. The computer program product of claim 15, wherein the hash table comprises part of a secure data block that is stored in a non-volatile memory of the computer system.

18. The computer program product of claim 15, wherein the first means comprises means for enabling the processing unit to randomly select one of the portions of the software image.

19. The computer program product of claim 15, further comprising fourth means for enabling the processing unit to execute the first means, the second means and the third means during execution of the software image.

20. The computer program product of claim 15, wherein the fourth means comprises means for enabling the processing unit to execute the first means, the second means and the third means on a periodic basis during execution of the software image.

21. The computer program product of claim 15, further comprising fourth means for enabling the processing unit to execute the first means, the second means and the third means during boot up of the computer system.

22. The computer program product of claim 15, further comprising:
fourth means for enabling the processing unit to shut down the computer system responsive to a determination that the software image is not authentic.
